(19) United States
(12) Patent Application Publication
(10) Pub. No.: US 2005/0091360 A1
(43) Pub. Date: Apr. 28, 2005

(54) Remote control device

(76) Inventors: Yuan-Tung Chen, Ho Lung Town (TW); Chien-Chen Lai, Taipei (TW)

Correspondence Address: RABIN & BERDO, P.C., Suite 500, 1101 14 Street, N.W., Washington, DC, 20005, US

(21) Appl. No.: 10/873,117

(22) Filed: Jun. 23, 2004

(30) Foreign Application Priority Data
Sep. 29, 2003 (TW) 92126904

(51) Int. Cl. G06F 15/177; G06F 15/173

(52) U.S. Cl. 709/223

(57) ABSTRACT

A remote control device is described. The remote control device uses a network chip directly mounted on a motherboard of a server computer to remote control the server computer without any additional network card requirement. The remote control device includes a basic input output system (BIOS), a COM port, a baseboard management controller (BMC), and a network chip. The BIOS redirects video data to the COM port and then the same to the BMC. The BMC transforms the video data into network packets according to a Q-Telnet protocol. The BMC recognizes the Q-Telnet protocol and a standard Telnet protocol effectively. Therefore, the network chip uses a UDP 623 port to control the BMC and a TCP 23 port to transmit data and commands using the standard Telnet protocol.

### BACKGROUND OF THE INVENTION

1. Field of Invention

The invention relates to a remote control device of a server computer and, in particular, to a remote control device that uses intelligent platform management interface (IPMI) side band standard on the server computer to reduce conventional network terminals and wirings.

2. Related Art

As computers become popular and with the rapid development in network technology, people can quickly obtain desired information and various kinds of services through the Internet. The development of computer network indeed brings us convenient and comfortable life.

Transmission technology utilizing the network has a lot of progress in recent years. Therefore, conventional computer systems comprised of few centralized computers or equipments are insufficient. The computer system used in a normal company no longer contains only a few computers. Instead, they are often composed of distributed computers and devices, such as the workstations, servers, databases, routers, and backup devices, distributed at different locations but connected by way of the network in order to provide various services.

To effectively manage computer devices at different locations, the importance of remote control is increasing. For the moment, an economic and effective remote server computer management method is implemented through the IPMI standard. IPMI is a monitoring system based upon the low pin count (LPC) bus standard. Using the IPMI standard, it is possible to perform rapid remote system maintenance. In addition, using the baseboard management controller (BMC), the system motherboard and communication tools can be more effectively integrated together for remote control and management of the server computer.

However, the remote management of server computers is often implemented through devoted network cards and channels along with a remote Telnet protocol in order to make use of the remote control of the server using the remote screen and keyboard. This remote management using devoted network cards and channels not only increases the hardware cost required for remote management, but also increases the external network wiring.

Therefore, how to provide a remote control device that can effectively use existing hardware devices without new hardware requirement is an important issue. This can reduce the cost of remote control and make the remote control more popular. The server management will become more convenient and efficient.

### SUMMARY OF THE INVENTION

As described above, the conventional remote management of server computers is implemented through devoted network cards and channels along with the Telnet protocol. Therefore, it increases the hardware cost and the complication of external network wiring. It is therefore imperative to provide a remote control device that only requires existing hardware on the server to remote control server computers. This will reduce the cost required for remote control and make remote management more popular and efficient.

An objective of the invention is to provide a remote control device that uses the existing network chip on the server motherboard to transmit remote control data and commands.

Another objective of the invention is to provide a Q-Telnet protocol of the Telnet protocol for remote control of the server. (Telnet is the TCP protocol and Q-Telnet is the UDP protocol.)

A further objective of the invention is to use a network chip complying with the IPMI side band standard to perform remote control of the server computer by way of the UDP 623 port.

According to the above-mentioned objectives, the invention provides a remote control device. A remote computer is used to remote control a server computer. The server computer can transmit data with the remote computer via the remote control device using merely the network chip mounted on the server computer motherboard, without the requirement of an additional devoted network chip or network card.

The remote control device contains a basic input/output system (BIOS), a COM port, a baseboard management controller (BMC), and a network chip. The BIOS redirect video data displayed on the monitor of the server computer to the COM port, and then to the BMC. The video data are transformed into network packets according to a predetermined communication protocol. The BMC recognizes the predetermined protocol and a standard Telnet protocol effectively.

The network chip is installed on the motherboard of the server computer and transmits the network packets with the BMC using the side band. The network packets are transmitted to the remote computer via a computer network, displaying on the monitor of the remote computer the video data displayed on that of the server computer. The video data include the monitor screen of the server computer executing the disk operating system (DOS) and/or the monitor screen of the server computer executing power on self test (POST).

The BMC has the ability of supporting the IPMI. The network chip complies with the IPMI side band standard, using the UDP 623 port as the transmission interface. The above-mentioned predetermined protocol is the Q-Telnet protocol. The network packet in the Q-Telnet protocol contains a Q-Telnet head, a RMCP head, and a UDP head.

Another embodiment of the invention is a remote control system. It includes a remote computer and a network to connect to the server computer. The remote computer uses a keyboard to input commands and transmits input network packets formed according to the Q-Telnet protocol to the server computer via the network. The server computer contains the above-mentioned remote computer device. Its BMC decodes the input network packets to control the server computer.

The disclosed remote control system utilizes the BMC and the remote computer, that can recognize the Q-Telnet protocol and the standard Telnet protocol, and the network chip complying with the IPMI side band standard and mounted on the server motherboard to remote control the server computer from the remote computer. It does not require additional devoted network chips. Therefore, the remote control system of the invention can effectively reduce the hardware cost for remote control on the server computer.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of structure in a preferred embodiment of the disclosed remote control device;

FIG. 2A compares the Q-Telnet protocol structure of the disclosed remote control device with the conventional Telnet protocol structure; and

FIG. 2B compares the Q-Telnet packet format of the disclosed remote control device with the conventional Telnet packet format.

### DETAILED DESCRIPTION OF THE PREFERRED EMBODIMENT

This specification discloses a remote control device. It makes the most use of the existing network chip mounted on the motherboard for remote server control. It is incompatible with the current standard Telnet protocol. The invention can thus reduce the cost for remote server control and popularize the remote management of servers.

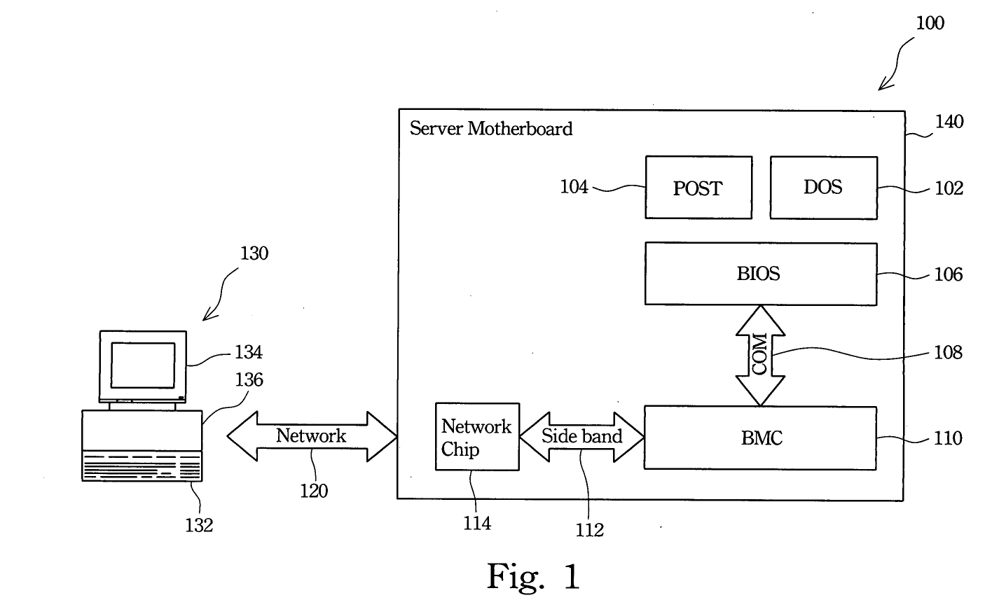

As shown in FIG. 1, the remote control device 100 contains a server motherboard 140. Through the collaboration between the basic input/output system (BIOS) 106 and the baseboard management controller (BMC) 110 installed thereon, the video data produced by the disk operating system (DOS) 102 or the power on self test (POST) 104 currently running on the server computer are redirected by the BIOS 106 to a COM port 108. Through the BMC 110, the video data are transmitted to the network chip 114 directly mounted on the server motherboard 140 by way of the side band input/output (10) interface 112. The video data displayed on the server computers are further transmitted to a remote computer 130 via a computer network 120.

The remote computer 130 contains a keyboard 132, a monitor 134, and a host 136. After the video data displayed on the server are received by the remote computer 130 via the computer network 120, they are displayed on the monitor 134. Control commands entered using the keyboard 132 are transformed by the host 136 into network packets recognizable by the server computer. The network packets are transmitted via the computer network 120 back to the network chip 114 for the server motherboard 140 to be controlled.

The network chip 114 is a network communication chip complying with the intelligent platform management interface (IPMI) side band standard. The IPMI standard adopts the user datagram protocol (UDP) 623 port as the transmission interface, whereas the conventional standard Telnet protocol uses the transmission control protocol (TCP) 23 port for input/output (IO). Traditionally, when using the standard Telnet protocol to output the video data displayed on the monitor of the server computer and to enter commands via the keyboard 132, the conventional remote control device inevitably has to use another independent network chip for the video data and command transmissions.

The network chip 114 used in the invention is a network communication chip complying with the IPMI side band standard. Therefore, it has the ability of using the UDP 623 port for side band IO. The disclosed remote control device 100 further uses a new predetermined protocol with side band transmission ability, such as the so-called Q-Telnet protocol, to transmit the data and commands required for remote control of the server computer. In addition to the use of the Q-Telnet protocol, the server computer performs the remote management of the server computer by way of the network chip 114. The standard Telnet protocol can be further used to perform the standard Telnet command and data transmissions by way of the network chip 114.

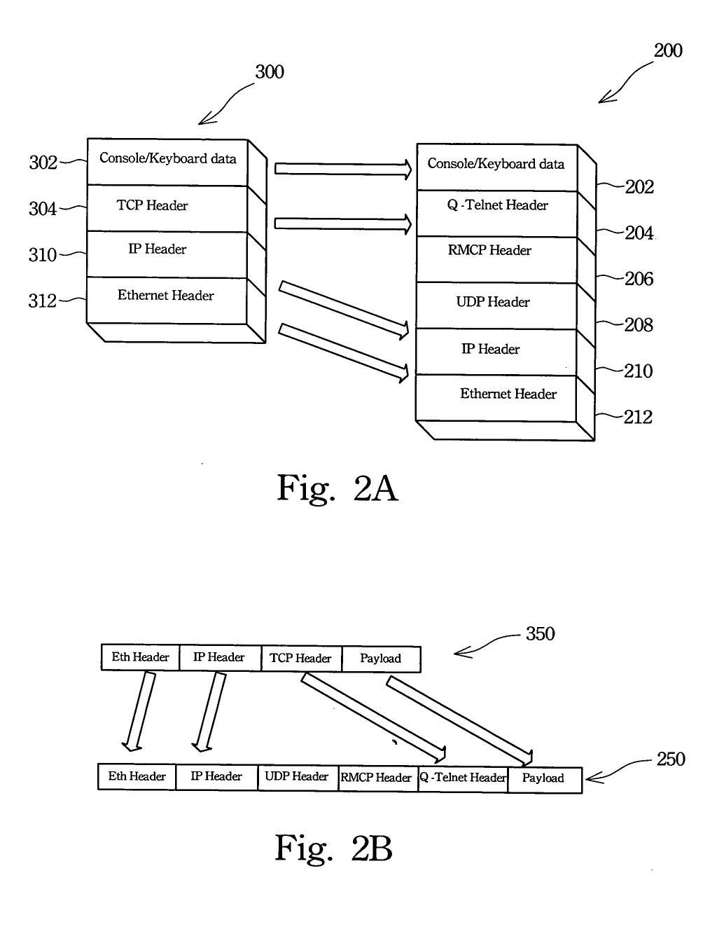

In the following, we combine FIGS. 2A and 2B to explain how the remote control device of the invention uses the Q-Telnet to transmit the data and commands required for remote control of the server computer. FIG. 2A compares the Q-Telnet protocol structure with the conventional standard Telnet protocol structure. FIG. 2B compares the Q-Telnet packet format with the conventional standard Telnet packet format.

As shown in FIG. 2A, the Q-Telnet protocol structure 200 contains the top-level local server monitor and the transmission of remote keyboard data 202. It further contains a Q-Telnet head 204, a remote management control protocol (RMCP) head 206, a user datagram protocol (UDP) head 208, an Internet protocol (IP) head 210, and an Ethernet head 212.

The conventional standard Telnet protocol structure 300 contains data of the local server monitor and the remote keyboard, a transmission control protocol (TCP) head 304, an IP head 310, and an Ethernet head 312.

In comparison with the standard Telnet that uses the TCP 23 port for data IO, the Q-Telnet of the invention uses the Q-Telnet head 204, the RMCP hear 206, and the UDP head 208 to replace the conventional TCP head 304. Both the server and the remote computer have the ability of executing the Q-Telnet protocol. Therefore, after the network packets transmitted from the Internet are received, if they are recognized as the network packets made according to the Q-Telnet protocol, the UDP 623 port are used as the 10 interface. Therefore, the BMC on the server motherboard can be directly controlled. When the network packet is prepared according to the standard Telnet protocol, the TCP 23 port is used to transmit data and commands accordingly.

The disclosed remote control device uses the UDP 623 port as the IO interface for server management. During remote Telnet using the Q-Telnet protocol, the UDP 623 is used as the 10 interface. Therefore, using the disclosed remote control device for remote Telnet, user can directly use the side band of the network chip mounted on the server motherboard to control the BMC, thereby controlling various functions on the server motherboard. Therefore, there is no interference with the TCP 23 port using the standard Telnet. That is, the disclosed remote control device can use the network chip directly mounted on the server motherboard to remotely control the BMC, without the requirement of an additional network chip or network card as the devoted network for remote controlling the BMC.

In order for the server computer and the remote computer 130 to recognize network packets complying with the Q-Telnet protocol transmitted by way of the network, the Q-Telnet network packet format 250, in comparison with the standard Telnet network packet format 350, further contains a Q-Telnet head, a RMCP head, and a UDP head in place of the conventional TCP head, as shown in FIG. 2B. Therefore, either the remote computer 130 or the server computer can recognize the transmitted network packet according to the Q-Telnet therein, determining whether it is a normal standard Telnet network packet or a Q-Telnet network packet. When the transmitted network packet uses the standard Telnet protocol, then it is the network packet for remote Telnet and uses the TCP 23 port for IO. When the transmitted network packet uses the Q-Telnet protocol, then it is the network packet for controlling and managing the BMC 110 and the server motherboard 140 and uses the UDP 623 port for side band IO.

From the above description, the disclosed remote control device utilizes the recognition power provided by the Q-Telnet protocol and the network chip complying with the IPMI side band standard to simultaneously transmit Q-Telnet packets for controlling the BMC and standard Telnet packets for remote Telnet. Thus, the hardware cost required for remote controlling the server can be reduced. The server management is not limited by distance any more.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A remote control device using a remote computer to control a server computer, the remote control device comprising:
a basic input/output system (BIOS), which redirects video data of the server computer;
a COM port, which connects to the BIOS to receive the redirected video data;
a baseboard management controller (BMC), which connects to the COM port for transferring the redirected video data according to a predetermined protocol into network packets, the BMC being able to recognize the predetermined protocol and a standard Telnet protocol; and
a network chip, which connects to the BMC, using a side band and the BMC to transmit the network packets, and transmitting the network packets to the remote computer by way of a computer network for displaying the video data on a monitor of the remote computer.

2. The remote control device of claim 1, wherein the video data include the monitor image of the server executing the disk operating system (DOS).

3. The remote control device of claim 1, wherein the video data include the monitor image of the server executing the power on self test (POST).

4. The remote control device of claim 1, wherein the BMC supports the intelligent platform management interface (IPMI).

5. The remote control device of claim 4, wherein the network chip complies with the IPMI side band standard and is mounted on a motherboard of the server computer.

6. The remote control device of claim 5, wherein the network chip uses the UDP 623 port as a transmission interface.

7. The remote control device of claim 1, wherein the predetermined protocol is a Q-Telnet protocol incompatible with the standard Telnet protocol.

8. The remote control device of claim 7, wherein the network packet using the Q-Telnet protocol contains at least a Q-Telnet header, a RMCP header, and a UDP header.

9. A remote control system comprising:
a remote computer, which contains:
a keyboard;
a host computer; and
a monitor;
a computer network; and
a server computer with a remote control device, the remote control device including:
a basic input/output system (BIOS), which redirects video data of the server computer;
a COM port, which connects to the BIOS to receive the redirected video data;
a baseboard management controller (BMC), which connects to the COM port for transferring the redirected video data according to a predetermined protocol into network packets, the BMC being able to recognize the predetermined protocol and a standard Telnet protocol; and
a network chip, which connects to the BMC, using a side band and the BMC to transmit the network packets, and transmitting the network packets to the remote computer by way of a computer network for displaying the video data on a monitor of the remote computer;
wherein the remote computer uses the keyboard to enter a command that is converted into an input network packet by the host computer according to the predetermined protocol and transmitted by way of the computer network to the remote control device, the BMC decodes the input network packet in order to control the server computer.

10. The remote control system of claim 9, wherein the video data include the monitor image of the server executing the disk operating system (DOS).

11. The remote control system of claim 9, wherein the video data include the monitor image of the server executing the power on self test (POST).

12. The remote control system of claim 9, wherein the BMC supports the intelligent platform management interface (IPMI).

13. The remote control system of claim 12, wherein the network chip complies with the IPMI side band standard and is mounted on a motherboard of the server computer.

14. The remote control system of claim 13, wherein the network chip uses the UDP 623 port as a transmission interface.

15. The remote control system of claim 9, wherein the predetermined protocol is a Q-Telnet protocol incompatible with the standard Telnet protocol.

16. The remote control system of claim 15, wherein the network packet using the Q-Telnet protocol contains at least a Q-Telnet header, a RMCP header, and a UDP header.

17. A remote control device using a remote computer to control a server computer, the remote control device comprising:
a basic input/output system (BIOS), which redirects video data of the server computer;
a COM port, which connects to the BIOS to receive the redirected video data;
a baseboard management controller (BMC), which supports the intelligent platform management interface (IPMI), connects to the COM port for transfer the redirected video data according to a Q-Telnet protocol into network packets, the BMC being able to recognize the Q-Telnet protocol and a standard Telnet protocol that are incompatible with each other; and
a network chip, which is mounted on a motherboard of the server computer, connected to the BMC, and compatible with the IPMI side band, and uses a side band and the BMC interface to transmit the network packets, transmitting the network packets to the remote computer by way of a computer network for displaying the video data on a monitor of the remote computer.

18. The remote control device of claim 17, wherein the video data include at least one monitor image of the server executing the disk operating system (DOS) and the server executing the power on self test (POST).

19. The remote control device of claim 17, wherein the network chip uses the UDP 623 port as a transmission interface.

20. The remote control device of claim 17, wherein the network packet using the Q-Telnet protocol contains at least a Q-Telnet header, a RMCP header, and a UDP header.
